(19) United States
(12) Patent Application Publication
(10) Pub. No.: US 2012/0321765 A1
(43) Pub. Date: Dec. 20, 2012

(54) Self Adhesive Bags for Steam Cooking in a Microwave Oven

(75) Inventor: Guy Darell Unwin, Cheltenham (GB)

(73) Assignee: Planit Products Ltd., Malvern, Worcestershine , (GB)

(21) Appl. No.: 13/581,825

(22) PCT Filed: Feb. 28, 2011
(86) PCT No.: PCT/GB2011/000268

§ 371 Date: Aug. 30, 2012

(30) Foreign Application Priority Data
Mar. 1, 2010 (GB) 1003368.6

(51) Int. Cl. B65D 33/18; A23L 1/01

(52) U.S. Cl. 426/234; 219/735; 426/523

(57) ABSTRACT

According to the present invention there is provided a flexible container for use by the end user as a cooking utensil. Said container comprises a front and rear panel formed of a food safe material and sealed at three sides, the rear panel being extended beyond the front panel on the unsealed fourth side to form a flap. On the upper side of the flap is formed an adhesive strip provided with a removable cover strip intended to be removed by the user when closing the container. The user is instructed to fold the container across both layers rather than simply across the junction of the flap and front panel in order to seal it prior to cooking. This creates a container which is effectively sealed but which is capable of releasing excess pressure above that level needed to steam the contents thoroughly. At the opposite end and sides of the container, away from the flap, a second weld parallel to the sealed edge may be formed on one or more sides in order to create an area which is not subject to the steam effect which occurs when food is heated, thus forming a cooler area for handling by the user when the product is cooked and removed from the microwave oven.

This invention relates to improvements in the cooking of food in a microwave oven, whereby food can be cheaply and effectively cooked by steaming the food in a self venting bag without losing the nutritional value of the food.

The background to the invention is that since the advent of the microwave oven there has been considerable interest in providing a container for food, particularly industrially packaged food suitable for use in a microwave oven, which is capable of maintaining a positive pressure and thus steaming the food as in a pressure cooker. As is well known, cooking of food in a pressurized container accelerates the heating effect and thus saves energy. However, the manufacture of a flexible container capable of withstanding the pressure generated and at the same time providing a clean and efficient means of allowing the escape of water vapour usually means that the package becomes expensive to produce. In addition, the problems associated with re-use are considerable, causing such a product to be both expensive to manufacture and difficult to re-use. The present invention is designed for the consumer rather than the packaged food industry as a cheap, quick and easy means of cooking.

Searches have produced many instances of prior art, but none which appear to provide a container inexpensive enough for single use by the consumer and capable of being re-usable. WO 2009146324 KOENIGKRAMER discloses a simple container featuring interlocking zip fittings to front and back walls, one part of which is relatively weak in order to vent excess pressure. EP 1880954 KANZAKI reveals a heat sealed pouch package whose seal is weaker by virtue of being less wide in one place than in the remainder of the seal while EP 1867583 NISHI shows a bag which releases excess steam, unfortunately without revealing the mechanism. There are many applications for grant of a patent, particularly from Japan, where the staple food of rice can be advantageously cooked in the user's microwave oven. However, none of the applications found appear to have been granted. Further examples include US 2006257056 MIYAKE which features a Z-shaped seal at one end which has a weaker section incorporated therein, JP 2007331816 HARUNA which shows a laminated construction featuring a pressure release vent chipped into the edge seal, JP 2007284118 MIYAKE which tells of a bag folded at one end and provided with a steam release vent and easy separable tape, JP 2007204072 NAKANAGA which reveals a resin based container provided with a vent formed by the juxtaposition of a heat sealed and an adhesively sealed seam and JP 2007191199 TAKEDA et al which discloses a bag with a flap that is variably sealed to the opposite face of the container in order to produce an unsealed zone connected to a vent. Other references include JP 2007137478 ITO et al, JP 2006327590 KAWAMOTO et al, JP 2006321519 SUGIYAMA et al, and JP 2006111327 ARAKI et al.

CA 2597828 MACDONALD teaches of a laminated bag whose laminates interlock along a seam forming a steam vent which will open when the pressure mounts inside the container. WO 02080623 THOMPSON reveals a microwaveable bag comprising two layers with an absorbent material between them while U.S. Pat. No. 4,987,280 KANAFANI discloses a sealed bag containing a sealed packet of an aqueous solution and a food product, the packet being intended to rupture and thereby steam the contents when heated. US 2001043971 JOHNS shows a sealed bag packaged with a food product and having an absorbent material on top of the food product while U.S. Pat. No. 4,874,620 MENDENHALL discloses a ventable sealed package comprising inner permeable and outer impermeable layers with gussets at the side and an arrangement of perforations and slits that permit venting from the external layer. All of these inventions suffer from deficiencies that the present invention seeks to overcome.

According to the present invention there is provided a flexible container for use by the end user as a cooking utensil. Said container comprises a front and rear panel formed of a food safe material and sealed at three sides, the rear panel being extended beyond the front panel on the unsealed fourth side to form a flap. On the upper side of the flap is formed an adhesive strip provided with a removable cover strip intended to be removed by the user when closing the container. The user is instructed to fold the container across both layers rather than simply across the junction of the flap and front panel in order to seal it prior to cooking. This creates a container which is effectively sealed but which is capable of releasing excess pressure above that level needed to steam the contents thoroughly. At the opposite end and sides of the container, away from the flap, a second weld parallel to the sealed edge may be formed on one or more sides in order to create an area which is not subject to the steam effect which occurs when food is heated, thus forming a cooler area for handling by the user when the product is cooked and removed from the microwave oven. The user places the foodstuff in the container, removes the removable cover of the sealing strip and folds the flap and a part of both layers before pressing the strip onto the upper panel of the container to seal the package and then places said container in the microwave oven to cook for the requisite time. On removal from the oven the user unseals the flap and removes the foodstuff.

The container will be made in a range of sizes but will typically be of a size less than the diameter of an average domestic microwave oven in order to allow it to rotate freely when being heated in said oven. A diagonal measurement of 320 mm from corner to corner of the container will therefore be practical, resulting in a maximum length of 240 mm, although other sizes may be required for other types of oven. The container may be formed in a variety of ways but will in practice be made by sealing a front panel and a rear panel either by welding or adhesive means. The adhesive strip and its protective covering strip will typically be applied together to the top flap after the container is formed. Any secondary seals to form handling sections may be formed in the same process as the formation of the container or may be formed subsequently. The adhesive strip attached to the flap will typically extend across the full width of the top flap but may extend across a lesser proportion thereof without substantially altering its effectiveness.

When the container is placed in the microwave oven and subjected to the heating effect therein any water content in the food will begin to turn to steam and thereby inflate the container. If required, water may be added but in general this step is not required. When this inflation occurs the fold where the top flap has been folded onto the front panel of the container increasingly tightens against the pressure thus improving the sealing effect. The design attempts to retain the generated pressure but having only a partial seal the pressure is slowly released as said pressure increases, thereby preventing rupture of the container. The vented steam passes through the fold into the area formed between the flap, the front panel of the container and the adhesive sealing strip and thence out to atmosphere at the distal edges of said area. This simple mechanism has been found to work extremely well without recourse to more complex contrivances adopted in other patent applications.

The container thus formed is simple enough to make inexpensively for sale in a multiple package as a single use product, although in tests it has been found that each container is capable of reuse several times. It ideally features printing on the front face to indicate at least the means of use and to mark the ideal line at which to fold the container prior to use. It can be made of an organic and biodegradable material such as corn starch or cellulose and thus avoids the waste generated by using a plastic material like polyethylene which is used in bags sealed by an interlocking zip strip as featured in KOENIGKRAMER. Alternative means of sealing the front and rear panels to each other may be employed and the handling sections at each of the three sealed sides may be created by means other than heating, such as an adhesive coating.

The method of use of the invention therefore comprises the following steps: placing the foodstuff into the container;

removing the protective strip attached to the adhesive strip;
folding'the top flap to meet the front panel of the container across front and rear panels;
securing the top flap to the front panel by means of the adhesive strip;
placing the container into a microwave oven;
energising the oven for the required time;
removing the container from the microwave oven;
detaching the top flap from the front panel of the container by pulling apart the adhesive bond;
removing the cooked foodstuff from the container and;
placing the foodstuff on a plate or other receptacle.

In the following drawings it is not intended to exclude features from another Figure from each specific embodiment but rather to provide a basis for their combination in specific applications.

While the invention has been disclosed in its preferred form, it is to be understood that the specific embodiment thereof, as described and illustrated herein, is not to be considered in a limited sense, as there may be other forms or modifications of the invention which should also be construed to come within the scope of the appended claims.

Specific embodiments of the invention will now be described by way of example with reference to the accompanying drawings in which:

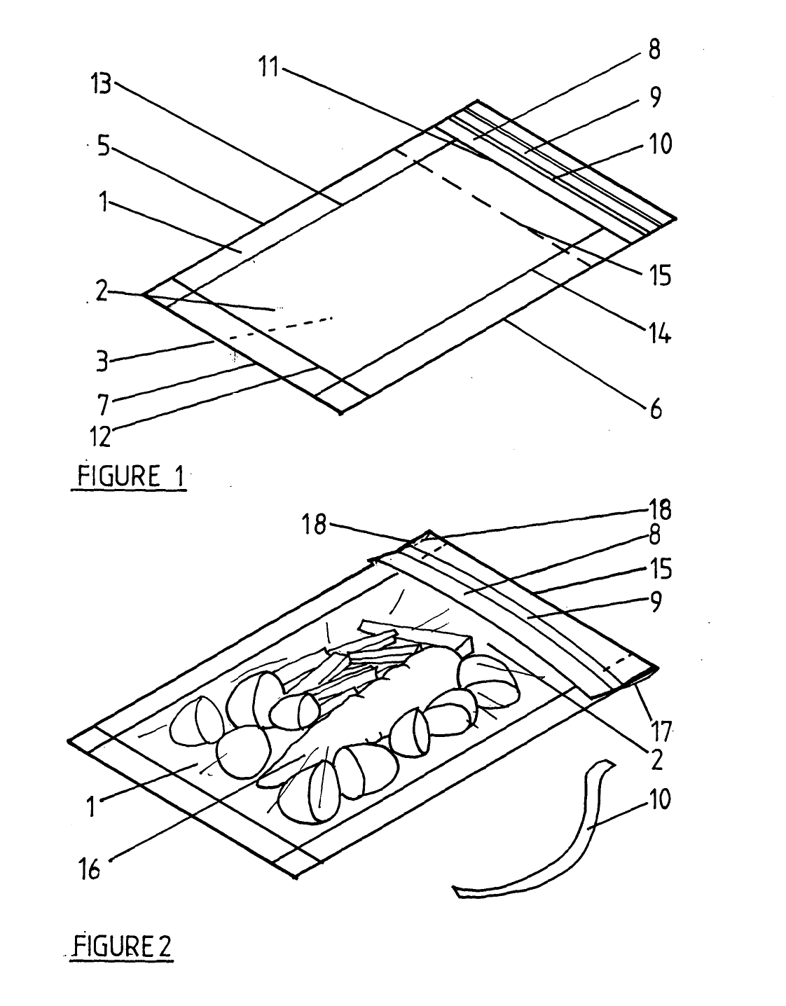

FIG. 1 shows the essential features of the invention;

FIG. 2 shows the invention in its sealed state.

Referring to the drawings, FIG. 1 shows the container 1 comprising front panel 2 and rear panel 3, edges 5 and 6, end seal 7, flap 8, adhesive strip 9 and removable strip 10, top margin 11 of front panel 2, second seal 12 and secondary side seals 13 and 14 and printed fold line 15.

FIG. 2 shows the container 1 in its folded state where the flap 8 has been folded along the printed fold line 15. The removable strip 10 has been removed and the flap 8 has been pressed down onto the front panel 2 to attach the adhesive strip 9 to said front panel 2. An assortment of vegetables 16 is shown contained within the container 1 ready for heating in the oven. On heating, escaping steam from the vegetables will pass the partial seal formed by the fold at the printed fold line 15 and outwards to atmosphere through the unsealed areas 17 and 18.

1. A container for the cooking of food made of at least one sheet of food grade microwave transparent non-insulating material comprising:
a front and a longer rear panel sealed at three sides to form a bag with a mouth and a flap at the mouth,
said flap having adhesive means on the side of the flap nearest to the mouth of said bag in order to close said bag,
said adhesive means comprising an adhesive strip and removable covering strip across all or part of the width of said bag,
said bag to be folded across both front and rear panel by the user and sealed, in order to cook the contents placed within said container by the efficient and nutritious means of steaming under pressure within a microwave oven while permitting release of excess pressure.

2. The container as claimed in claim 1 featuring a line, instruction or other indication of the place that said bag should be folded by the user when sealing said bag by means of said adhesive strip in order to maintain an optimum seal against the pressure generated by the steam emitted by the contained food when heated, said indication being positioned to effect a fold comprising both front and rear panels of said bag.

3. The container as claimed in claim 1 wherein said adhesive means comprises an adhesive means positioned across a proportion of the width of said flap or front panel of said container.

4. The container as claimed in claim 1 made of a material suitable for food packaging selected from the families of polypropylene polyethylene polyester and nylon.

5. The container as claimed in claim 1 made of a biodegradable food grade material such as corn starch or cellulose.

6. The container as claimed in claim 1 having a secondary seal parallel with the sealed side edge at any of the other three sides to prevent ingress of steam to that portion of the container between the sealed edge and the secondary seal in order to form a holding means which remains cool to the touch.

7. The container as claimed in claim 1 formed of a material capable of withstanding temperatures up to 230 degrees Centigrade for cooking food in a conventional oven.

8. A method of using a container as claimed in claim 1 comprising the steps of:
placing the foodstuff into the container;
removing the protective strip attached to the adhesive strip;
folding the flap across both front and rear panels to meet the front panel of the container;
securing the top flap to the front panel by means of the adhesive strip;
placing the container into a microwave oven;
energising the oven for the required time;
removing the container from the microwave oven;
detaching the top flap from the front panel of the container;
removing the cooked foodstuff from the container and;
placing the foodstuff on a plate or other receptacle.

9. A method of using a container as claimed in claim 1 comprising the steps of:
placing the foodstuff into the container;
folding the flap across both front and rear panels to meet the front panel of the container;
securing the top flap to the front panel by means of the adhesive strip;
placing the container into a conventional oven;
energising the oven for the required time;
removing the container from the oven;
detaching the top flap from the front panel of the container;
removing the cooked foodstuff from the container and;
placing the foodstuff on a plate or other receptacle.

10. (canceled)
